(19) United States
(12) Patent Application Publication
(10) Pub. No.: US 2017/0205500 A1
(43) Pub. Date: Jul. 20, 2017

(54) ULTRASONIC PROBE AND ULTRASONIC APPARATUS

(71) Applicant: Seiko Epson Corporation, Tokyo (JP)

(72) Inventor: Kanechika KIYOSE, Matsumoto (JP)

(21) Appl. No.: 15/399,011

(22) Filed: Jan. 5, 2017

(30) Foreign Application Priority Data
Jan. 19, 2016 (JP) 2016-008069

(51) Int. Cl. G01S 7/52; G01S 15/89; G10K 11/00

(52) U.S. Cl. CPC G01S 7/52079; G10K 11/004; G01S 15/8915; G10K 11/30

(57) ABSTRACT

An ultrasonic probe includes a transmitting unit including a transmitting surface that transmits ultrasonic waves, a receiving unit including a receiving surface that receives the ultrasonic waves, and a receiving attitude changing unit that changes an angle of the receiving unit, wherein a part of the transmitting unit includes a second receiving unit (group of transmitting and receiving transducers) that can receive the ultrasonic waves.

### BACKGROUND

1. Technical Field

The present invention relates to an ultrasonic probe, an ultrasonic apparatus, etc.

2. Related Art

In related art, ultrasonic apparatuses each including a transmitting transducer that transmits ultrasonic waves and a receiving transducer that receives the ultrasonic waves output from the transmitting transducer and reflected by an object are known.

In the ultrasonic apparatus, when the transmitting surface of the transmitting transducer and the receiving surface of the receiving transducer are the same surface (or parallel surfaces), reception signals of ultrasonic waves received by the receiving transducer become lower. That is, when ultrasonic waves are transmitted from the transmitting transducer in a first direction, of the ultrasonic waves reflected by an object, the ultrasonic waves reflected along the first direction have the highest intensity and are most preferable to be received. However, actually, the receiving transducer is located in a position different from the transmitting transducer, and the ultrasonic waves reflected at angles tilted with respect to the first direction are received by the receiving transducer. In this case, signal values (voltages) of the reception signals become lower.

On the other hand, ultrasonic apparatuses having transmitting transducers and receiving transducers at variable angles are known (for example, Patent Document 1 (JP-A-2013-124978).

An apparatus described in Patent Document 1 is an ultrasonic apparatus for searching for cracks in pipe walls of piping in which inclination angles of a transmitting probe (transmitting transducer) and a receiving probe (receiving transducer) and a distance between the transmitting transducer and the receiving transducer are variable. In the apparatus, positions of beads are detected using a vertical transmitting and receiving probe provided separately from the transmitting transducer and the receiving transducer. A distance between rotation shafts of the transmitting probe and the receiving probe, an exit angle of ultrasonic waves of the receiving probe, and an incident angle of reflected ultrasonic waves of the receiving probe are set in advance. The apparatus searches pipes near the beads in which cracks are liable to be produced by transmission and reception of ultrasonic waves and determines presence or absence of cracks of pipes.

Patent Document 1 is aimed at pipes having known diameter dimensions. In other words, depths from the ultrasonic probe in which the transmitting transducer and the receiving transducer are provided to reflection positions of ultrasonic waves are known. Accordingly, the placement and the angles of the transmitting transducer and the receiving transducer can be set based on the known depths.

On the other hand, for example, when an object that reflects ultrasonic waves is a tissue within a living body (e.g. blood vessel or the like), the depth of the object is unknown or the position thereof changes. In this case, it is difficult to determine the position (depth) of the reflection of the ultrasonic wave received by the receiving transducer and the measurement accuracy becomes lower.

### SUMMARY

An advantage of some aspects of the invention is to provide an ultrasonic probe and an ultrasonic apparatus with higher measurement accuracy.

An ultrasonic probe according to an application example of the invention includes a transmitting unit that transmits ultrasonic waves, a first receiving unit that receives the ultrasonic waves, and a changing mechanism that changes arrangement of at least one of the transmitting unit and the first receiving unit, wherein apart of the transmitting unit includes a second receiving unit that can receive the ultrasonic waves.

In this application example, the changing mechanism is provided and changes the arrangement of at least one of the transmitting unit and the first receiving unit. The changing of the arrangement described here includes not only changing an angle of at least one of the transmitting unit and the first receiving unit but also changing a distance between the transmitting unit and the first receiving unit by sliding movement of at least one of the transmitting unit and the first receiving unit or the like. Further, the transmitting unit contains the second receiving unit that receives the ultrasonic waves.

In an ultrasonic probe in which the transmitting unit and the first receiving unit are respectively independent, when ultrasonic waves transmitted from the transmitting unit and reflected in a predetermined reflection position within an object (reflected waves) are received by the first receiving unit, the transmission direction of the ultrasonic waves of the transmitting unit and the reception direction of the reflected waves received by the first receiving unit are different. Accordingly, when the transmitting unit and the first receiving unit are on the same plane, the reflected waves are obliquely received by the first receiving unit, and sound pressure of the received ultrasonic waves is smaller and a signal output from the first receiving unit is smaller.

On the other hand, in the configuration in which the changing mechanism is provided as in the application example, the arrangement (angles and positions) of the transmitting unit and the first receiving unit may be changed so that the normal direction of the first receiving unit may be a direction toward the reflection position. Accordingly, the reception direction of the reflected waves received by the first receiving unit can be nearly aligned with the normal direction of the first receiving unit. Thus, reduction of the sound pressure of the ultrasonic waves is suppressed and output reduction of the signal output from the first receiving unit is suppressed. Therefore, a reception time (first time) after transmission of ultrasonic waves from the transmitting unit and before reception of the reflected waves in the first receiving unit may be measured with higher accuracy.

Now, in the ultrasonic probe, the above described first time is measured, and thereby, the position of the object reflecting the ultrasonic waves is measured. That is, the reflection position of the ultrasonic wave in the object may be calculated by measurement of the input time of the reflected wave input to the first receiving unit. However, in the case where the inclination angle of the first receiving unit with respect to the transmitting unit is changed, the depth of the reflection position changes depending on the attitudes of the transmitting unit and the first receiving unit, and calculation of the depth is difficult using only the signal from the first receiving unit.

On the other hand, in the application example, the second receiving unit is provided within the transmitting unit and a time (second time) after the ultrasonic waves are transmitted from the transmitting unit and before the reflected waves are received in the second receiving unit is measured, and thereby, the time after transmission of ultrasonic waves from the transmitting unit and before reaching the reflection position in the object (i.e., the distance from the transmitting unit to the reflection position of the ultrasonic waves) may be calculated. Therefore, the above described first time and second time are used, and thereby, the reflection position of the ultrasonic waves may be measured with higher accuracy. Further, the second receiving unit contained in the transmitting unit is provided for receiving the reflected waves returned along the transmission direction of the ultrasonic waves (e.g., the normal direction of the transmitting unit), and the signal intensity is larger and the second time may be measured with higher accuracy.

Thereby, in the application example, the measurement of the reflection position of ultrasonic waves in the object may be performed with higher accuracy.

In the ultrasonic probe according to the application example, it is preferable that the transmitting unit includes a transmitting array in which a plurality of ultrasonic transmitting transducers that transmit the ultrasonic waves are arranged in an array form.

In the application example with this configuration, the transmitting unit has the transmitting array in which the plurality of ultrasonic transmitting transducers are arranged in the array form. For example, the transmitting array may have a one-dimensional array structure in which the plurality of ultrasonic transmitting transducers are arranged in a first direction (scanning direction) or a two-dimensional array structure in which the plurality of ultrasonic transmitting transducers are arranged in the first direction and a second direction crossing the first direction. In the case of the two-dimensional array structure, for example, the ultrasonic transmitting transducers along the second direction (slice direction) are connected to be simultaneously driven to form a 1-ch group of ultrasonic transmissions, and thereby, can function as a one-dimensional array structure.

In the case where the transmitting array has the one-dimensional array structure, the respective ultrasonic transmitting transducers (or the group of ultrasonic transmissions) along the first direction are driven with delays, and thereby, ultrasonic waves can be transmitted into a surface (scanning surface) containing the normal direction and the first direction of the transmitting unit. The reflected waves are received by the first receiving unit, and thereby, inner tomographic images with respect to the scanning surface of the object may be acquired.

Further, the transmitting array has the two-dimensional array structure and the respective ultrasonic transmitting transducers can be individually driven, and thereby, ultrasonic waves can be transmitted from the transmitting array in an arbitrary direction. The reflected waves are received by the first receiving unit, and thereby, a three-dimensional image with respect to the object can be acquired.

In the ultrasonic probe according to the application example, it is preferable that the second receiving unit is provided at a center of the transmitting array.

In the application example with this configuration, the second receiving unit is provided at the center of the transmitting array, and thereby, the distance from the center of the transmitting unit to the reflection position of the ultrasonic waves in the object may be calculated.

In the ultrasonic probe according to the application example, a plurality of the second receiving units may be provided, and the plurality of second receiving units may be arranged in positions symmetric with respect to a predetermined reference position in the transmitting array.

In the application example with this configuration, the plurality of second receiving units are arranged in positions symmetric with respect to the predetermined reference position. Note that, as the reference position, e.g. the center position of the transmitting array or the like may be exemplified. In the configuration, the distance from the transmitting unit to the reflection position of the ultrasonic waves may be calculated with higher accuracy based on the reception results of the plurality of second receiving units.

In the ultrasonic probe according to the application example, it is preferable that the second receiving unit is a transmitting and receiving transducer that can transmit and receive the ultrasonic waves.

In the application example with this configuration, the transmitting and receiving transducer is used as the second receiving unit. In this case, the transmitting and receiving transducer of the second receiving unit may be used for transmission of ultrasonic waves at transmission of the ultrasonic waves, and sound pressure of the transmitted ultrasonic waves may be increased.

In the ultrasonic probe according to the application example, the second receiving unit may be a receiving transducer that performs reception of the ultrasonic waves.

In the application example with this configuration, the second receiving unit includes the receiving transducer. When transmission and reception of ultrasonic waves are performed by the ultrasonic probe, for example, in the receiving unit (first receiving unit or second receiving unit), second harmonics reflected in the reflection position of the object may be received. In this case, frequencies of the ultrasonic waves transmitted from the transmitting unit and the reflected waves received in the second receiving unit are different, and it is necessary to differentiate the size of the vibrating part when the ultrasonic waves are transmitted and the size of the vibrating part when the ultrasonic waves are received. In this case, if the second receiving unit is formed by the above described transmitting and receiving transducer, it is impossible to receive harmonics in the second receiving unit. On the other hand, in the application example, the second receiving unit is the receiving transducer of ultrasonic waves and it is only necessary that the unit is formed by the vibrating part according to the frequency of the received ultrasonic waves, and the reflected waves may be suitably received.

In the ultrasonic probe according to the application example, it is preferable that the first receiving unit includes a receiving array in which a plurality of ultrasonic receiving transducers that receive the ultrasonic waves are arranged in an array form.

In the application example with this configuration, the first receiving unit is formed by the array structure. The array structure of the first receiving unit may be a one-dimensional array structure or two-dimensional array structure as is the case where the transmitting unit has the array structure. In the case of the two-dimensional array structure, a group of ultrasonic receptions may be formed with the ultrasonic receiving transducers along the first direction as one channel and function as a one-dimensional array. In this case, the respective groups of ultrasonic receptions are formed by the plurality of ultrasonic receiving transducers, and thereby, the reception signals may be amplified and the reception sensitivity may be made better.

Further, the reflected waves from the reflection position of the object are respectively received by the respective ultrasonic receiving transducers (or groups of ultrasonic receptions), and thereby, the reflection position may be calculated with higher accuracy based on the phase differences of the reception signals.

In the ultrasonic probe according to the application example, it is preferable that the transmitting unit includes a first acoustic lens, the first receiving unit includes a second acoustic lens, and a curvature of the first acoustic lens and a curvature of the second acoustic lens are equal.

In the application example with this configuration, the curvatures of the first acoustic lens provided in the transmitting unit and the second acoustic lens provided in the first receiving unit are the same. In the configuration, the first acoustic lens is provided, and thereby, the ultrasonic waves transmitted from the respective positions of the transmitting unit are output with phase differences depending on the positions and can be converged on a predetermined focal position of the object. Further, the reflected waves are received in the first receiving unit via the second acoustic lens having the same curvature as the first acoustic lens, and thereby, the phase differences of the respective ultrasonic waves are eliminated and the reflected waves can be received with higher accuracy in the first receiving unit.

An ultrasonic apparatus according to an application example of the invention includes an ultrasonic probe including a transmitting unit that transmits ultrasonic waves, a first receiving unit that receives the ultrasonic waves, and a changing mechanism that changes arrangement of at least one of the transmitting unit and the first receiving unit, a part of the transmitting unit including a second receiving unit that can receive the ultrasonic waves, and a control unit that controls the ultrasonic probe.

In this application example, the above described ultrasonic probe is controlled by the control unit. In the ultrasonic probe, the above described highly accurate measurement may be performed. Therefore, in the ultrasonic apparatus, inner tomographic images of the object may be measured with higher accuracy based on the signals output from the ultrasonic probe.

In the ultrasonic apparatus according to the application example, it is preferable that the control unit controls the changing mechanism so that a reception signal from the first receiving unit may be equal to or larger than a predetermined value based on a reception signal from the second receiving unit.

In the application example with this configuration, the control unit controls the changing mechanism based on the signals from the second receiving unit. As described above, the time (distance) from the transmitting unit to the reflection position of the object may be calculated based on the signals from the second receiving unit. Therefore, the changing mechanism is controlled based on the second signals so that the reception direction of the first receiving unit may be toward the reflection position (the reception signals take a predetermined value or more), and thereby, highly accurate measurement based on the signals from the first receiving unit with higher signal intensity may be performed.

### BRIEF DESCRIPTION OF THE DRAWINGS

The invention will be described with reference to the accompanying drawings, wherein like numbers reference like elements.

FIG. 1 is a block diagram showing a schematic configuration of an ultrasonic apparatus of the first embodiment.

FIG. 2 is a perspective view schematically showing an ultrasonic probe of the first embodiment.

FIG. 3 is a schematic sectional view of the ultrasonic probe of the first embodiment.

FIG. 4 is a plan view showing a schematic configuration of a transmitting device board forming a transmitting unit of the first embodiment.

FIG. 5 is a sectional view schematically showing the transmitting unit of the first embodiment.

FIG. 6 is a plan view showing a schematic configuration of a receiving device board forming a receiving unit of the first embodiment.

FIG. 7 is a sectional view schematically showing the receiving unit of the first embodiment.

FIG. 8 is a flowchart showing an ultrasonic measuring method of the first embodiment.

FIGS. 9A and 9B are diagrams for explanation of attitude control of the receiving unit in the first embodiment.

FIG. 10 is a schematic sectional view of an ultrasonic probe of the second embodiment.

FIG. 11 is a flowchart showing an ultrasonic measuring method of the second embodiment.

FIGS. 12A and 12B are diagrams for explanation of attitude control of a transmitting unit and a receiving unit in the second embodiment.

FIG. 13 is a plan view showing a schematic configuration of a transmitting device board forming a transmitting unit of the fourth embodiment.

FIG. 14 shows a configuration example of a transmitting device board of another embodiment.

### DESCRIPTION OF EXEMPLARY EMBODIMENTS

### First Embodiment

As below, the first embodiment will be explained.

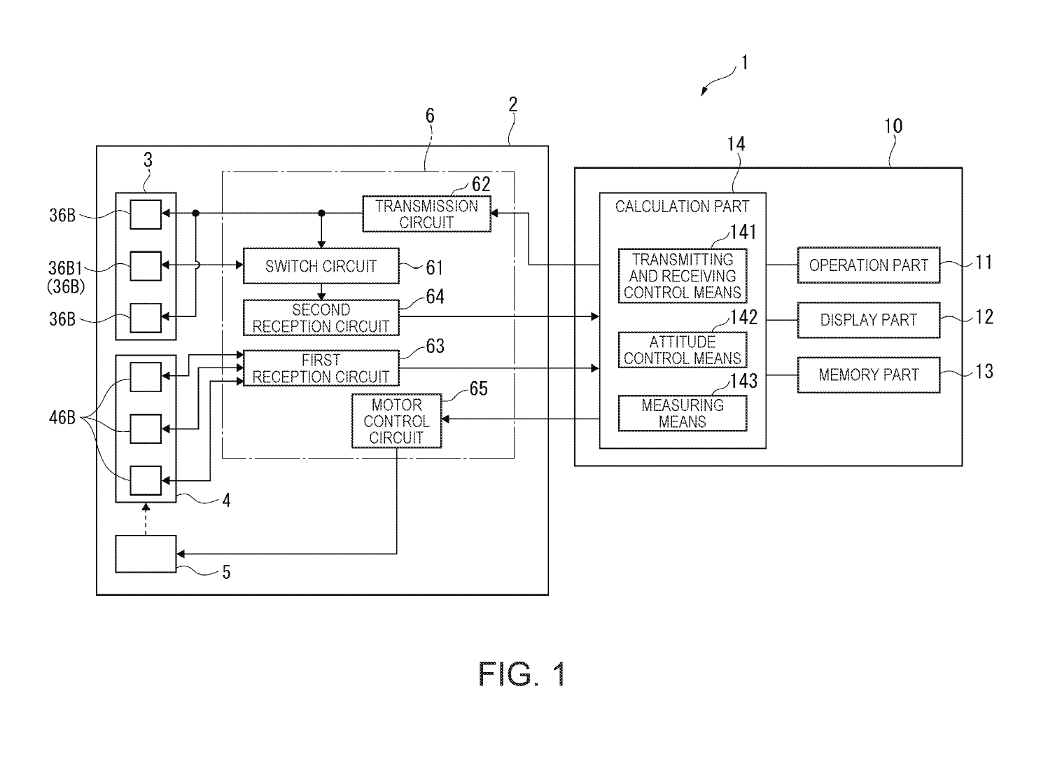

FIG. 1 is a block diagram showing a schematic configuration of an ultrasonic apparatus of the first embodiment.

As shown in FIG. 1, an ultrasonic apparatus 1 of the embodiment includes an ultrasonic probe 2 and a control unit 10 that controls the ultrasonic probe 2.

The ultrasonic apparatus 1 brings the ultrasonic probe 2 into contact with a surface of a living body (e.g. human body) and transmits ultrasonic waves from the ultrasonic probe 2 into the living body. Further, the apparatus receives ultrasonic waves (reflected waves) reflected by an organ within the living body in the ultrasonic probe 2, and, for example, acquires inner tomographic images within the living body and measures statuses of the organ within the living body (e.g. blood flow, blood pressure, etc.) based on the reception signals.

### Configuration of Ultrasonic Probe 2

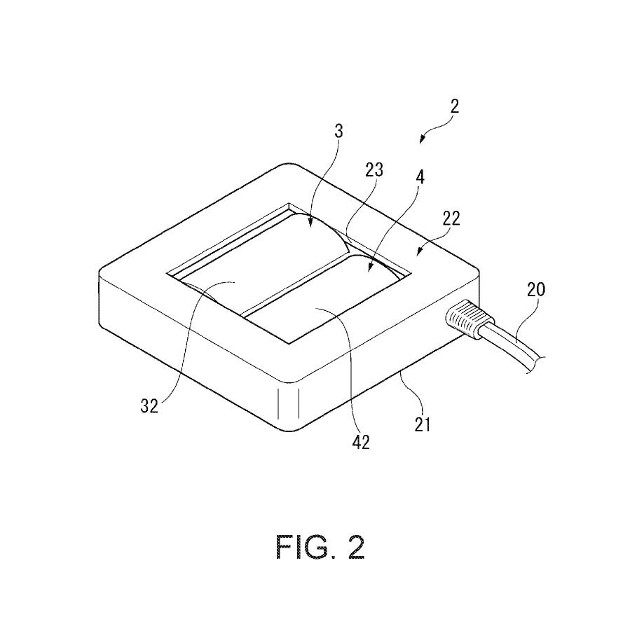

FIG. 2 is a perspective view schematically showing the ultrasonic probe 2 of the embodiment.

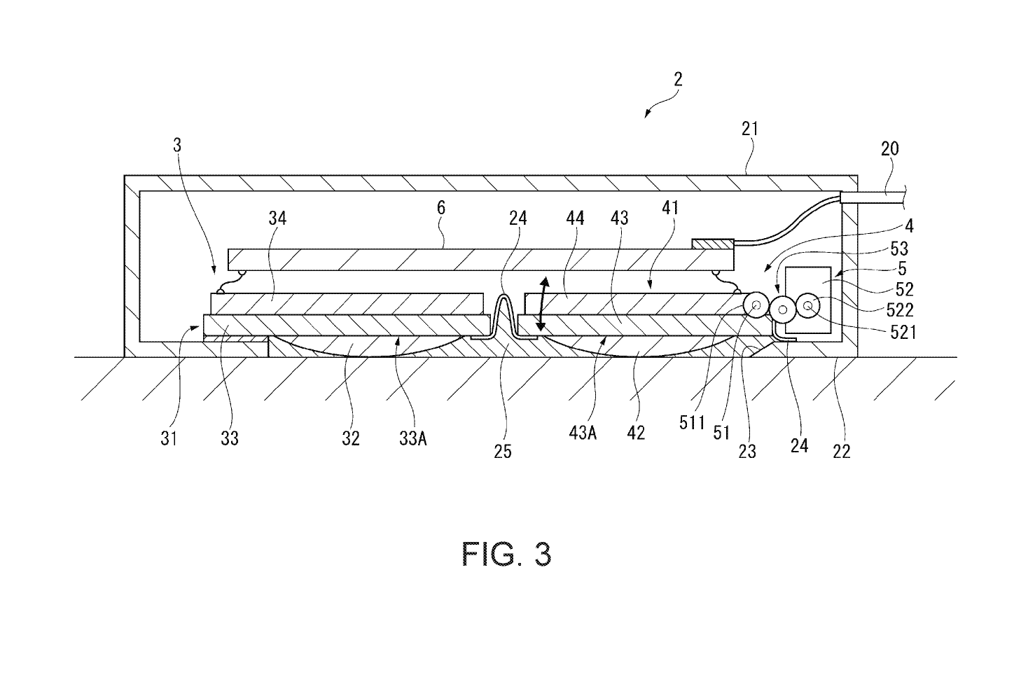

FIG. 3 is a schematic sectional view of the ultrasonic probe 2 of the embodiment.

As shown in FIGS. 1 to 3, the ultrasonic probe 2 includes a casing 21, a transmitting unit 3, a receiving unit 4 (first receiving unit), a receiving attitude changing unit 5 (changing mechanism), and a circuit board 6.

The casing 21 is formed in e.g. a box shape, and houses the transmitting unit 3, the receiving unit 4, the receiving attitude changing unit 5, the circuit board 6, etc. inside. The casing 21 has one surface serving as a sensor surface 22 to be in contact with the living body. A sensor window 23 is provided in the sensor surface 22 and parts of the transmitting unit 3 and the receiving unit 4 are exposed in the sensor window 23.

Note that, in the embodiment, the receiving unit 4 has a rotatable configuration, and flexible waterproof sheets 24 are joined to an end portion of the transmitting unit 3 on the receiving unit 4 side and an end portion of the receiving unit 4 on the transmitting unit 3 side in order to ensure the waterproof property between the transmitting unit 3 and the receiving unit 4 and the transmitting unit 3 and the receiving unit 4 are connected.

Further, a cable 20 that communicably connects the ultrasonic probe 2 and the control unit 10 is connected to a part of the casing 21 (e.g. a side surface crossing the sensor surface 22 or an upper surface opposite to the sensor surface 22).

### Configuration of Transmitting Unit 3

The transmitting unit 3 is fixed to a predetermined position of the casing 21. The transmitting unit 3 includes e.g. a transmitting board part 31 and a first acoustic lens 32, and the first acoustic lens 32 is exposed to the outside from the sensor window 23 as shown in FIGS. 2 and 3.

Further, in the embodiment, the transmitting board part 31 is fixed by being joined to the inner wall of the casing 21 and the attitude of the transmitting unit 3 with respect to the casing 21 is unchanged. Note that a waterproof mechanism (not shown) is provided in a fixing part between the transmitting board part 31 and the casing 21.

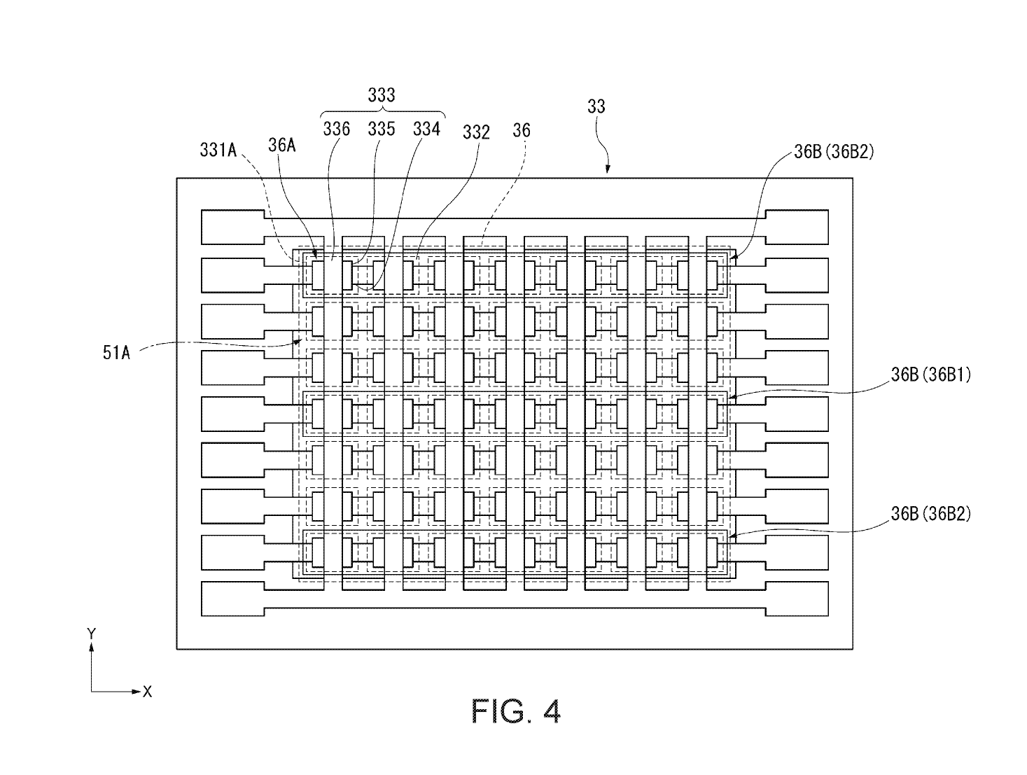

FIG. 4 is a plan view showing a schematic configuration of a transmitting device board 33 forming the transmitting unit 3.

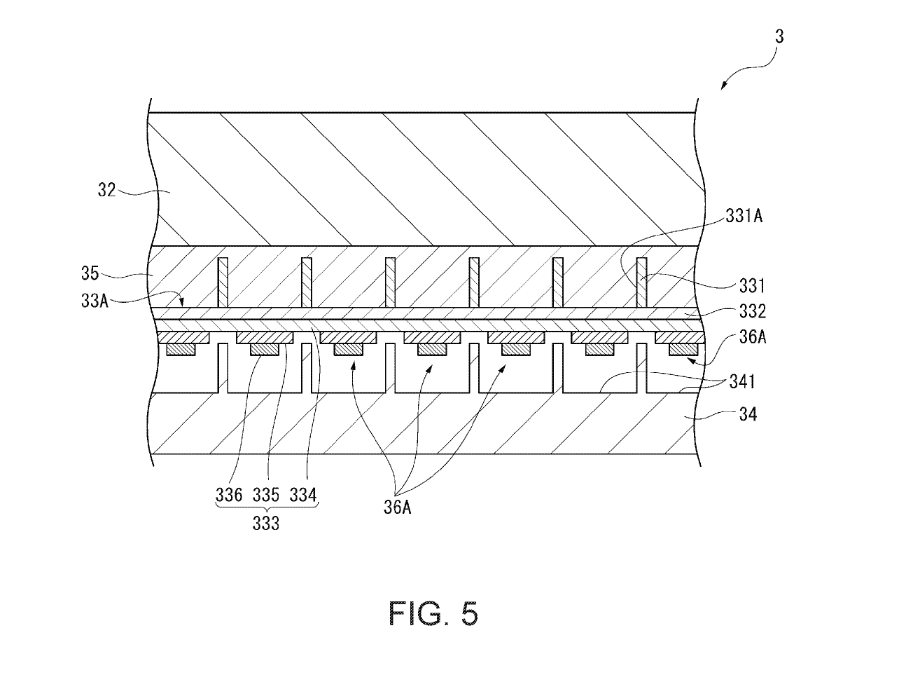

FIG. 5 is a sectional view schematically showing the transmitting unit 3.

The transmitting board part 31 includes the transmitting device board 33 and a transmission reinforcing plate 34 that reinforces the transmitting device board 33. Further, an acoustic matching layer 35 is provided between the transmitting board part 31 and the first acoustic lens 32.

### Configuration of Transmitting Device Board 33

As shown in FIG. 5, the transmitting device board 33 includes a board main body part 331, a vibrating diaphragm 332 provided on the transmission reinforcing plate 34 side of the board main body part 331, and piezoelectric elements 333 stacked on the vibrating diaphragm 332. Here, the surface of the vibrating diaphragm 332 of the transmitting device board 33 (a boundary surface between the acoustic matching layer 35 and the diaphragm) serves as a transmitting surface 33A. In the embodiment, the transmitting surface 33A is parallel to the sensor surface 22.

Further, in a plan view of the transmitting device board 33 as seen from the board thickness direction, a plurality of ultrasonic transducers 36A are arranged in a matrix form in the center area of the transmitting device board 33 and form a transmitting array 36 having a two-dimensional array structure. Here, these plurality of ultrasonic transducers 36A are ultrasonic transmitting transducers and transmit ultrasonic waves. Further, though the details will be described later, of the plurality of ultrasonic transducers 36A, a predetermined number of ultrasonic transducers 36A provided in the center position of the transmitting array 36 in the Y-direction and arranged in the X-direction serve as transmitting and receiving transducers, and these ultrasonic transducers 36A form a group of transmitting and receiving transducers 36B1 as a second receiving unit.

The board main body part 331 includes a semiconductor substrate of Si or the like, for example, and opening portions 331A corresponding to the respective ultrasonic transducers 36A are provided within the transmitting array 36 of the board main body part 331. Further, the respective opening portions 331A are closed by the vibrating diaphragm 332.

The vibrating diaphragm 332 includes a stacked structure of SiO₂ or SiO₂ and ZrO₂ or the like, for example, and provided to cover the entire of the board main body part 331 on the transmission reinforcing plate 34 side. The thickness dimension of the vibrating diaphragm 332 is sufficiently smaller than that of the board main body part 331.

As shown in FIG. 5, on the vibrating diaphragm 332 closing the respective opening portions 331A, the piezoelectric elements 333 as stacked structures of lower electrodes 334, piezoelectric films 335, and an upper electrode 336 are provided. Here, the vibrating diaphragm 332 closing the opening portion 331A and the piezoelectric element 333 form the single ultrasonic transducer 36A.

In the ultrasonic transducer 36A, a rectangular wave voltage at a predetermined frequency is applied between the lower electrode 334 and the upper electrode 336, and thereby, the vibrating diaphragm 332 within the opening region of the opening portion 331A is vibrated and sends out ultrasonic wave according to the opening area of the opening portion 331A. Further, when the vibrating diaphragm 332 is vibrated by the reflected wave reflected from the object, a potential difference is generated between the upper part and the lower part of the piezoelectric film 335. Therefore, the potential difference generated between the lower electrode 334 and the upper electrode 336 is detected, and thereby, the received ultrasonic wave can be detected.

In the embodiment, as show in FIG. 4, the plurality of the above described ultrasonic transducers 36A are arranged within the predetermined transmitting array 36 of the transmitting device board 33 in the X-direction and the Y-direction crossing (in the embodiment, orthogonal to) the X-direction.

Here, the lower electrode 334 is formed in a linear shape along the X-direction and connects the respective ultrasonic transducers 36A arranged along the X-direction. Terminals to be connected to the circuit board 6 are provided on both ends of the lower electrode 334.

On the other hand, as shown in FIG. 4, the upper electrode 336 connects all of the ultrasonic transducers 36A within the transmitting array 36 and, for example, terminals projecting from the ends in the Y-direction toward the X-direction side are connected to the circuit board 6.

In the above described transmitting array 36, a 1-ch group of ultrasonic transducers 36B are formed by the ultrasonic transducers 36A connected by the lower electrode 334 and arranged in the X-direction, and an array arrangement having a one-dimensional array structure in which a plurality of the groups of ultrasonic transducers 36B are arranged in the Y-direction is obtained.

Further, though the details will be described later, of the plurality of groups of ultrasonic transducers 36B, the group of ultrasonic transducers 36B provided in the center position in the Y-direction are transmitting and receiving transducers (group of transmitting and receiving transducers) that perform both transmission and reception of ultrasonic waves.

### Configuration of Transmission Reinforcing Plate 34

The transmission reinforcing plate 34 has a planar shape as seen from the thickness direction formed in the same shape as that of the transmitting device board 33, for example, and includes a semiconductor substrate of Si or the like or an insulator substrate. Note that the material and the thickness of the transmission reinforcing plate 34 affect the frequency characteristics of the ultrasonic transducers 36A, and are preferably set based on the center frequency of ultrasonic waves to be transmitted and received by the ultrasonic transducers 36A.

In the transmission reinforcing plate 34, a plurality of concave grooves 341 corresponding to the opening portions 331A of the transmitting device board 33 are formed to face the transmitting array 36 of the transmitting device board 33. Thereby, of the vibrating diaphragm 332, in regions vibrated by the ultrasonic transducers 36A (within the opening portions 331A), a gap having a predetermined dimension is provided between the transmitting device board 33 and the regions and the vibration of the vibrating diaphragm 332 is not hindered. Further, inconvenience of back wave from one ultrasonic transducer 36A entering the other adjacent ultrasonic transducers 36A (crosstalk) may be suppressed.

When the vibrating diaphragm 332 vibrates, ultrasonic waves are emitted not only toward the opening portions 331A side (the transmitting surface 33A side) but also toward the transmission reinforcing plate 34 side as back waves. The back waves are reflected by the transmission reinforcing plate 34 and emitted toward the vibrating diaphragm 332 side again. In this regard, if the reflected back waves and the ultrasonic waves output from the vibrating diaphragm 332 are out of phase, the ultrasonic waves attenuate. Therefore, in the embodiment, the groove depth of each concave groove 341 is set so that the acoustic distance in the gap may be an odd multiple of a quarter of the wavelength λ (λ/4) of the ultrasonic waves. In other words, the thickness dimensions of the respective parts of the transmitting device board 33 and the transmission reinforcing plate 34 are set in consideration of the wavelength λ of the ultrasonic waves emitted from the ultrasonic transducers 36A.

In the transmission reinforcing plate 34, through holes (not shown) corresponding to the lower electrodes 334 and the upper electrode 336 are provided and wiring electrodes that connect the lower electrodes 334 and the upper electrode 336 and the circuit board 6 from the through holes are provided. As the wiring electrodes, for example, through electrodes penetrating the transmission reinforcing plate 34 may be provided, the terminal portions of the lower electrodes 334 and the upper electrode 336 may be connected to one ends of the through electrodes, and the terminal portion of the circuit board 6 may be connected to the other ends. Or, the terminal portions of the lower electrodes 334 and the upper electrode 336 and the terminal portion of the circuit board 6 may be connected by a flexible board, wires, or the like.

### Configurations of Acoustic Matching Layer 35 and First Acoustic Lens 32

As shown in FIG. 5, the acoustic matching layer 35 is provided on the transmitting surface 33A side of the transmitting device board 33. Specifically, the acoustic matching layer 35 fills the opening portions 331A of the transmitting device board 33 and is formed in a predetermined thickness dimension from the board main body part 331.

The first acoustic lens 32 is provided on the acoustic matching layer 35, and, as shown in FIGS. 2 and 3, exposed to the outside from the sensor window 23 of the casing 21. The first acoustic lens 32 has a cylindrical shape having an axis in the Y-direction in an arc-like sectional surface shape with respect to the X-direction. The curvature of the arc in the sectional surface with respect to the X-direction is the same curvature as that of the second acoustic lens 42, which will be described later.

These acoustic matching layer 35 and first acoustic lens 32 propagate the ultrasonic waves transmitted from the ultrasonic transducers 36A to a living body as a measuring object and efficiently propagate the ultrasonic waves reflected inside the living body to the ultrasonic transducers 36A. Accordingly, the acoustic matching layer 35 and the first acoustic lens 32 are set to acoustic impedance intermediate between the acoustic impedance of the ultrasonic transducers 36A and the acoustic impedance of the living body. As the raw material having the acoustic impedance, e.g. silicone or the like may be used.

### Configuration of Receiving Unit 4

The receiving unit 4 is provided in the X-direction side of the transmitting unit 3. The receiving unit 4 includes a receiving board part 41 and the second acoustic lens 42. The second acoustic lens 42 is exposed to the outside from the sensor window 23 like the first acoustic lens 32.

The receiving board part 41 is fixed to a rotation shaft 51 along the Y-axis direction on the opposite end to the transmitting unit 3, for example. The rotation shaft 51 rotates about the shaft center, and thereby, the receiving unit 4 rotates.

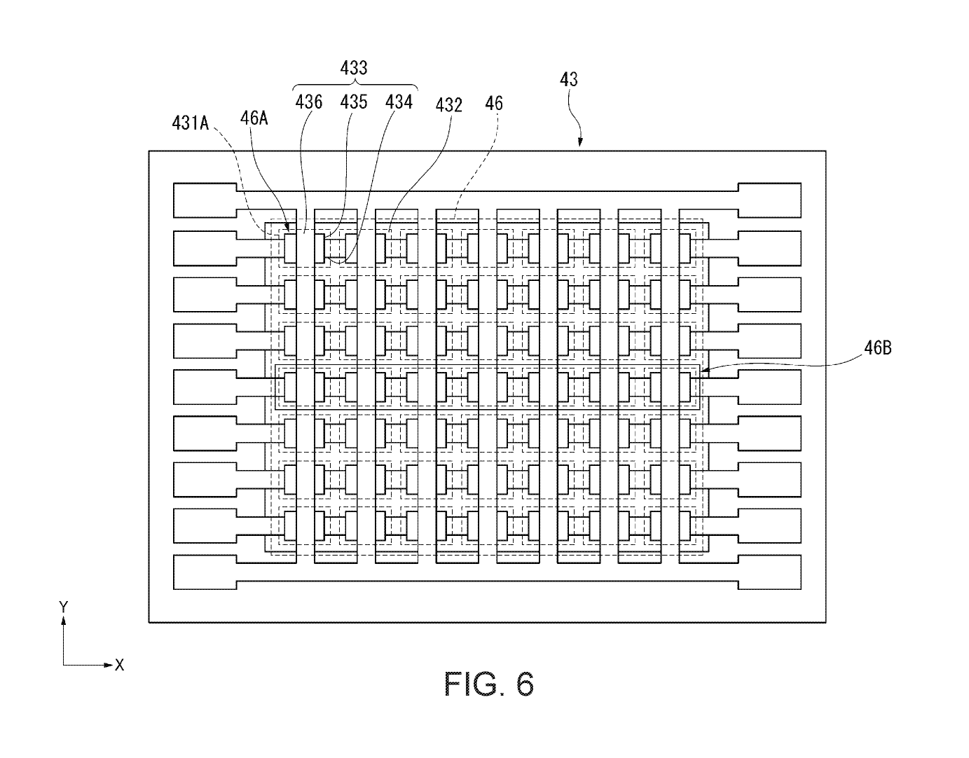

FIG. 6 is a plan view showing a schematic configuration of a receiving device board 43 forming the receiving unit 4.

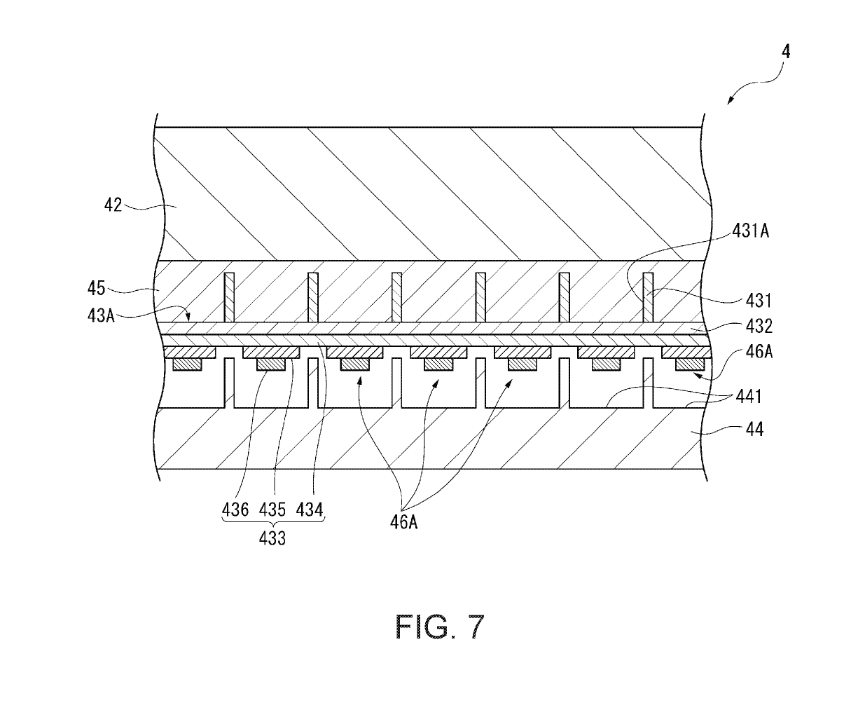

FIG. 7 is a sectional view schematically showing the receiving unit 4.

The receiving board part 41 includes the receiving device board 43 and a reception reinforcing plate 44 that reinforces the receiving device board 43. Further, an acoustic matching layer 45 is provided between the receiving board part 41 and the second acoustic lens 42. Note that the configurations of these receiving device board 43 and second acoustic lens 42 are nearly the same configurations as those of the above described transmitting device board 33 and first acoustic lens 32 and the explanation here is omitted.

### Configuration of Receiving Device Board 43

As shown in FIG. 7, the receiving device board 43 includes a board main body part 431, a vibrating diaphragm 432 provided on the reception reinforcing plate 44 side of the board main body part 431, and piezoelectric elements 433 stacked on the vibrating diaphragm 432. Here, the surface of the vibrating diaphragm 432 of the receiving device board 43 (a boundary surface between the acoustic matching layer 45 and the diaphragm) serves as a receiving surface 43A. In the embodiment, the receiving unit 4 is rotated by the receiving attitude changing unit 5, and thereby, the angle of the receiving surface 43A with respect to the transmitting surface 33A (sensor surface 22) is changed.

In the plan view of the receiving device board 43 as seen from the board thickness direction, a plurality of ultrasonic transducers 46A are arranged in a matrix form in the center area of the receiving device board 43 and form a receiving array 46 having a two-dimensional array structure. Here, these plurality of ultrasonic transducers 46A are ultrasonic receiving transducers and receive ultrasonic waves (reflected waves) from an object (living body).

The board main body part 431 has nearly the same configuration as that of the board main body part 331 of the transmitting device board 33, and opening portions 431A corresponding to the respective ultrasonic transducers 46A are provided within the receiving array 46 of the board main body part 431 and the respective opening portions 431A are closed by the vibrating diaphragm 432.

The vibrating diaphragm 432 is provided to cover the entirety of the board main body part 431 on the reception reinforcing plate 44 side like the board main body part 331 of the transmitting device board 33. The thickness dimension of the vibrating diaphragm 432 is sufficiently smaller than that of the board main body part 431.

As shown in FIG. 7, on the vibrating diaphragm 432 closing the respective opening portions 431A, the piezoelectric elements 433 as stacked structures of lower electrodes 434, piezoelectric films 435, and an upper electrode 436 are provided. Here, the vibrating diaphragm 432 closing the opening portion 431A and the piezoelectric element 433 form the single ultrasonic transducer 46A.

In the ultrasonic transducer 46A, when the vibrating diaphragm 432 is vibrated by the reflected wave reflected from the object, a potential difference is generated between the upper part and the lower part of the piezoelectric film 435. The potential difference generated between the lower electrode 434 and the upper electrode 436 is detected, and thereby, the received ultrasonic wave can be detected.

In the embodiment, as shown in FIG. 6, the plurality of the above described ultrasonic transducers 46A are arranged within the predetermined receiving array 46 of the receiving device board 43 in the X-direction and the Y-direction. Like the transmitting array 36, the lower electrode 434 is formed in a linear shape in the X-direction and connects the respective ultrasonic transducers 46A arranged in the X-direction. Terminals on both ends of the lower electrode 434 are connected to the circuit board 6.

As shown in FIG. 6, the upper electrode 436 connects all of the ultrasonic transducers 46A within the receiving array 46 and, for example, terminals projecting from the ends in the Y-direction toward the X-direction side are connected to the circuit board 6.

In the above described receiving array 46, a 1-ch group of ultrasonic transducers 46B are formed by the ultrasonic transducers 46A connected by the lower electrode 434 and arranged in the X-direction, and an array arrangement having a one-dimensional array structure in which a plurality of the groups of ultrasonic transducers 46B are arranged in the Y-direction is obtained.

### Configuration of Reception Reinforcing Plate 44

The reception reinforcing plate 44 has the same configuration as the transmission reinforcing plate 34, and includes a plurality of concave grooves 441 corresponding to the opening portions 431A of the receiving array 46. Further, in the reception reinforcing plate 44, through holes (not shown) corresponding to the lower electrodes 434 and the upper electrode 436 are provided and the terminal portions of the lower electrodes 434 and the upper electrode 436 and the terminal portion of the circuit board are connected by a flexible board, wires, or the like from the through holes.

The above described rotation shaft 51 is fixed to the end of the reception reinforcing plate 44 on the opposite side to the transmitting unit 3 in the X-direction.

### Configurations of Acoustic Matching Layer 45 and Second Acoustic Lens 42

As shown in FIG. 7, the acoustic matching layer 45 is provided on the receiving surface 43A side of the receiving device board 43. Specifically, the acoustic matching layer 45 fills the opening portions 431A of the receiving device board 43 and is formed in a predetermined thickness dimension from the board main body part 431.

The second acoustic lens 42 is provided on the acoustic matching layer 45, and, as shown in FIGS. 2 and 3, exposed to the outside from the sensor window 23 of the casing 21. The second acoustic lens 42 has a cylindrical shape having an axis in the Y-direction in an arc-like sectional surface shape with respect to the X-direction. The curvature of the arc in the sectional surface with respect to the X-direction is the same curvature as that of the first acoustic lens 32.

As described above, the curvatures of the first acoustic lens 32 and the second acoustic lens 42 are made equal, and thereby, the phase difference generated when the ultrasonic wave transmitted in the transmitting unit 3 passes through the first acoustic lens 32 is eliminated by the second acoustic lens 42 through which the ultrasonic wave passes when received by the receiving unit 4. Thereby, the phase at the transmission of the ultrasonic wave and the phase at the reception of the ultrasonic wave may be equal and the reception accuracy may be improved.

Note that, when the ultrasonic probe 2 is attached to the living body, as shown in FIG. 3, an acoustic matching material 25 (e.g. a liquid such as a gel) is applied to the sensor window 23. Thereby, the acoustic matching material 25 fills between the first acoustic lens 32 and the living body and between the second acoustic lens 42 and the living body.

Further, the transmitting unit 3 and the receiving unit 4 are connected by the flexible waterproof sheet 24, and thereby, entry of the liquid including the acoustic matching material 25 into the casing 21 from between the transmitting unit 3 and the receiving unit 4 may be suppressed. Furthermore, the same waterproof sheet may be provided between the outer periphery of the receiving unit 4 and the casing 21, and thereby, the waterproof property may be improved.

### Configuration of Receiving Attitude Changing Unit 5

The receiving attitude changing unit 5 rotates the receiving unit 4 based on the control of the control unit 10 and changes the inclination angle of the receiving surface 43A with respect to the transmitting surface 33.

The receiving attitude changing unit 5 may have any configuration that rotates the receiving unit 4. For example, in the embodiment, the part includes the rotation shaft 51, a stepping motor 52, and a drive transmission part 53.

As described above, the rotation shaft 51 is fixed to the end of the reception reinforcing plate 44 on the opposite side to the transmitting unit 3 in the X-direction and rotates with the reception reinforcing plate 44 (receiving unit 4). A first gear 511 is provided on a part (e.g. an end) of the rotation shaft 51.

The stepping motor 52 is electrically connected to the circuit board 6, for example, and driven based on a signal from the control unit 10 to rotate a motor shaft 521 about the shaft center. On the motor shaft 521, a second gear 522 is provided.

The drive transmission part 53 includes e.g. one or more gears that connect the first gear 511 and the second gear 522. When the stepping motor 52 is driven and the motor shaft 521 is rotated, the drive power is transmitted from the second gear 522 to the first gear 511 via the drive transmission part 53, and the rotation shaft 51 rotates. Thereby, the receiving unit 4 rotates with the rotation shaft 51.

### Configuration of Circuit Board 6

The circuit board 6 is provided with a driver circuit for controlling driving of the transmitting unit 3, the receiving unit 4, and the receiving attitude changing unit 5 etc. Specifically, as shown in FIG. 1, the circuit board 6 includes a switch circuit 61, a transmission circuit 62, a first reception circuit 63, a second reception circuit 64, a motor control circuit 65, etc.

Further, the circuit board 6 is electrically connected to the control unit 10 via a coaxial cable within the cable 20.

The switch circuit 61 is connected to a predetermined number of groups (e.g. 1-ch) of ultrasonic transducers 36B provided in the center position of the plurality of groups of ultrasonic transducers 36B provided in the transmitting array 36 of the transmitting unit 3 (hereinafter, the group of ultrasonic transducers 36B are referred to as a group of transmitting and receiving transducers 36B1 for distinction from the other groups of ultrasonic transducers 36B). The switch circuit 61 switches between transmission connection of connecting the group of transmitting and receiving transducers 36B1 and the transmission circuit 62 and reception connection of connecting the group of transmitting and receiving transducers 36B1 and the second reception circuit 64 (second receiving unit) based on the control of the control unit 10, for example.

The transmission circuit 62 is connected to the switch circuit 61 and the other groups of ultrasonic transducers 36B than the group of transmitting and receiving transducers 36B1 of the transmitting unit 3. The transmission circuit 62 outputs a voltage to be applied to the respective groups of ultrasonic transducers 36B of the transmitting unit 3 under the control of the control unit 10. A voltage signal from the transmission circuit 62 is input to the group of transmitting and receiving transducers 36B1 when the switch circuit 61 is switched to the transmission connection, and thereby, ultrasonic waves are output.

Here, the transmission circuit 62 applies a predetermined drive pulse signal (SIG signal) to the lower electrodes 334 of the groups of ultrasonic transducers 36B to drive and applies a predetermined common bias voltage (COM signal) to the upper electrode 336.

The first reception circuit 63 is connected to the respective groups of ultrasonic transducers 46B of the receiving unit 4. The first reception circuit 63 applies a predetermined common bias voltage (COM signal) to the upper electrode 436 of the respective groups of ultrasonic transducers 46B under the control of the control unit 10. Then, when the vibrating diaphragm 432 of the respective ultrasonic transducers 46A receives ultrasonic waves and is vibrated, reception signals are input from the lower electrodes of the respective groups of ultrasonic transducers 46B to the first reception circuit 63. Further, the first reception circuit 63 includes e.g. a low-noise amplifier circuit, a voltage control attenuator, a programmable gain amplifier, a low-pass filter, an A/D converter, etc. and performs conversion of the input reception signals into digital signals, removal of noise components, amplification to desired signal levels, and respective signal processing including phasing and adding processing of the respective groups of ultrasonic transducers 46B, and then, outputs the processed reception signals to the control unit 10.

The second reception circuit 64 is connected to the group of transmitting and receiving transducers 36B1 of the transmitting unit 3. The second reception circuit 64 applies a predetermined common bias voltage (COM signal) to the upper electrode 336 of the groups of transmitting and receiving transducers 36B1 when the switch circuit 61 is switched to the reception connection. Then, when ultrasonic waves are received in the group of transmitting and receiving transducers 36B1, reception signals are input from the lower electrodes 334. Like the first reception circuit 63, the second reception circuit 64 includes e.g. a low-noise amplifier circuit, a voltage control attenuator, a programmable gain amplifier, a low-pass filter, an A/D converter, etc. and performs respective signal processing including conversion of the input reception signals into digital signals, removal of noise components, amplification to desired signal levels, and then, outputs the processed reception signals to the control unit 10.

The motor control circuit 65 changes the attitude of (rotates) the receiving unit 4 by controlling the receiving attitude changing unit 5 under the control of the control unit 10. In the embodiment, the circuit applies a voltage to the stepping motor 52 based on the control signal from the control unit 10.

### Configuration of Control Unit 10

As shown in FIG. 1, the control unit 10 includes e.g. an operation part 11, a display part 12, a memory part 13, and a calculation part 14.

The operation part 11 is a UI (user interface) for a user to operate the ultrasonic apparatus 1, and includes e.g. a touch panel, an operation button, a keyboard, a mouse, etc. provided on the display part 12.

The display part 12 includes e.g. a liquid crystal display or the like and displays images.

The memory part 13 stores various programs and various data for controlling the ultrasonic apparatus 1.

The calculation part 14 includes e.g. an arithmetic circuit such as a CPU (Central Processing Unit) and a memory circuit such as a memory. The calculation part 14 reads and executes various programs stored in the memory part 13, and thereby, functions as a transmitting and receiving control unit 141, an attitude control unit 142, a measuring unit 143, etc.

The transmitting and receiving control unit 141 controls the switch circuit 61, the transmission circuit 62, the first reception circuit 63, and the second reception circuit 64 to perform transmission processing and reception processing of ultrasonic waves in the ultrasonic probe 2. For example, generation of transmission signals and control of output processing are performed with respect to the transmission circuit 62 and control of frequency settings and gain settings of the reception signals is performed with respect to the first reception circuit 63 and the second reception circuit 64.

The attitude control unit 142 calculates depths of the reflection positions based on the reception signals input from the second reception circuit 64, and controls the motor control circuit 65 to change the attitude (angle) of the receiving unit 4.

The measuring unit 143 calculates the reflection positions of the ultrasonic waves within the living body and generates inner tomographic images of the living body based on the reception signals input from the first reception circuit 63 and the reception signals input from the second reception circuit 64.

Ultrasonic Measuring Method using Ultrasonic Apparatus 1

Next, an ultrasonic measuring method using the above described ultrasonic apparatus 1 will be explained.

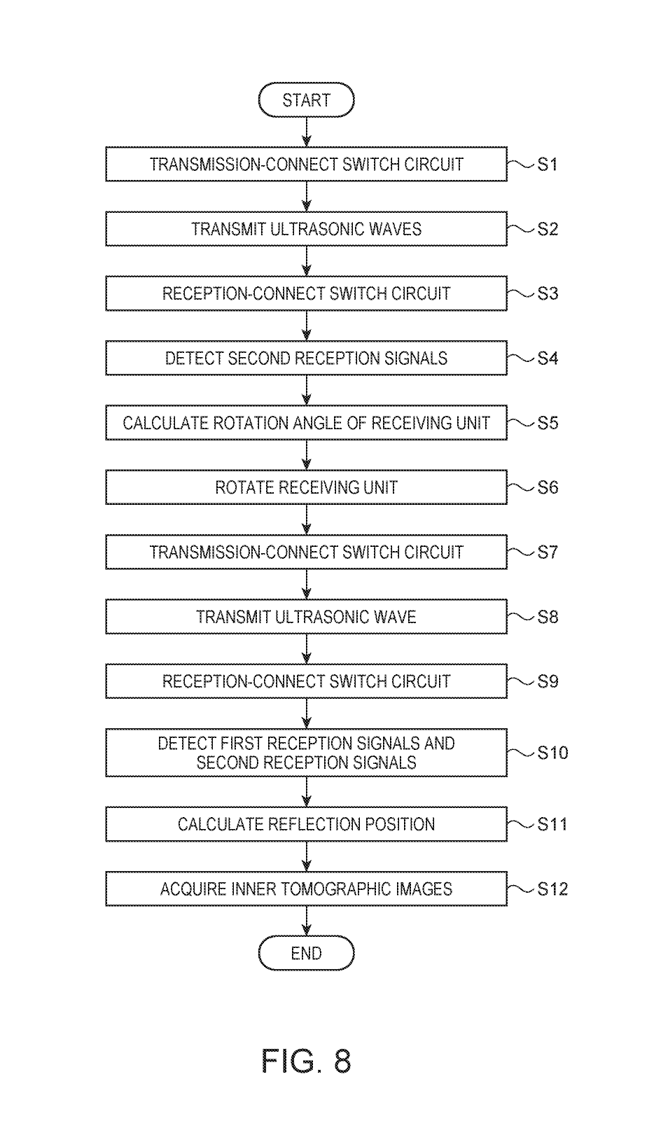

FIG. 8 is a flowchart showing the ultrasonic measuring method using the ultrasonic apparatus 1 of the embodiment.

When the ultrasonic measuring processing using the ultrasonic apparatus 1 of the embodiment is performed, first, the sensor window 23 of the ultrasonic probe 2 is filled with the acoustic matching material 25 and the ultrasonic probe 2 is closely fixed to a living body as an object.

Then, when a start instruction for the ultrasonic measuring processing is input by the operation of the operation part 11, for example, the transmitting and receiving control unit 141 switches the switch circuit 61 to the transmission connection (step S1), and applies a drive voltage to the respective groups of ultrasonic transducers 36B of the transmitting unit 3 from the transmission circuit 62 to transmit ultrasonic waves (step S2). Specifically, the transmitting and receiving control unit 141 controls the transmission circuit 62 to apply the SIG signal to the lower electrodes 334 and apply the COM signal to the upper electrode 336.

Then, the transmitting and receiving control unit 141 switches the switch circuit 61 to the reception connection (step S3), and detects the reception signals (second reception signals) from the group of transmitting and receiving transducers 36B1 by the second reception circuit 64 (step S4). That is, the transmitting and receiving control unit 141 controls the second reception circuit 64 to apply the COM signal to the upper electrode 336 and detect the reception signal output from the lower electrodes 334 by the second reception circuit 64.

Note that the processing from step S1 to step S4 may be performed at a plurality of times while the transmission direction of ultrasonic wave is changed by delaying the application time of the drive voltage input to the respective groups of ultrasonic transducers 36B with respect to each group of ultrasonic transducers 36B at step S2. In this case, ultrasonic waves may be transmitted to a predetermined scanning surface along the Y-direction and orthogonal to the transmitting unit 3 by the transmitting unit 3, and the measurement region may be set to a wider range (a nearly sector region about the transmitting surface 33A). Note that, in the embodiment, for convenience of explanation, a mode of outputting ultrasonic waves in the normal direction of the transmitting unit 3 (a mode without scanning with respect to the scanning surface) is exemplified.

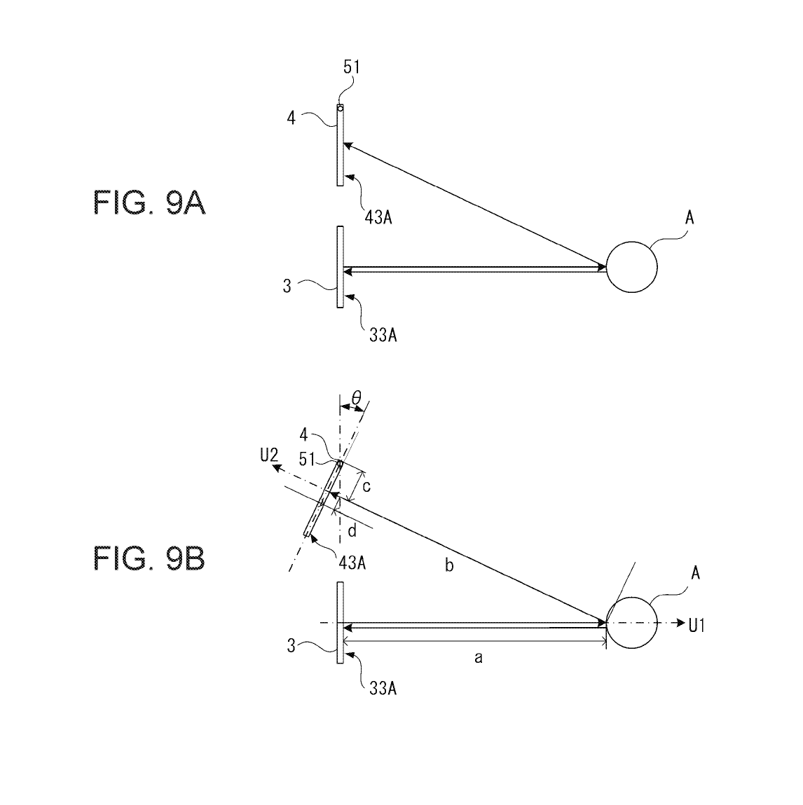

FIGS. 9A and 9B are diagrams for explanation of the attitude control of the receiving unit 4 in the embodiment.

When receiving the second reception signals from the second reception circuit 64 by the processing at step S4, the attitude control unit 142 calculates an angle to rotate the receiving surface 43A of the receiving unit 4 with respect to the transmitting surface 33A of the transmitting unit 3 (step S5), and rotates the receiving unit 4 by the calculated angle (step S6).

That is, as shown in FIG. 9A, when the transmitting surface 33A and the receiving surface 43A are parallel, the ultrasonic wave reflected in a reflection position A (measuring object) within an object (living body) is input at the angle inclined with respect to the normal direction of the receiving surface 43A. In this case, as described above, in the receiving unit 4, compared to the case where the ultrasonic wave is received from the normal direction of the receiving surface 43A, the vibration of the vibrating diaphragm 432 of the respective ultrasonic transducers 46A is smaller and signal intensity of the output reception signals is lower. Accordingly, in the embodiment, as shown in FIG. 9B, the attitude of the receiving unit 4 is changed so that the ultrasonic wave may enter from a direction nearly the same as the normal direction of the receiving surface 43A of the receiving unit 4.

Specifically, at step S5, the attitude control unit 142 calculates the distance from the transmitting unit 3 to the reflection position A, i.e., the depth of the reflection position A based on the reception signals from the second reception circuit 64. The ultrasonic wave from the transmitting unit 3 is output in the normal direction of the transmitting surface 33A, and, when the ultrasonic wave is reflected in the reflection position A, the reflected wave is input from the normal direction of the transmitting surface 33A. Therefore, the reception signals having higher signal intensity are output from the group of transmitting and receiving transducers 36B1 at step S4, and the time from the transmission time of ultrasonic wave to the reception time of the ultrasonic wave in the group of transmitting and receiving transducers 36B1 may be accurately measured. Therefore, a distance a from the transmitting unit 3 to the reflection position A may be calculated with high accuracy based on the time and the sound velocity.

A distance b between the transmitting unit 3 and the receiving unit 4 is known in advance, and the attitude control unit 142 calculates a rotation angle θ of the receiving unit 4 from 0=arc tan(b/a).

Then, the attitude control unit 142 outputs a control signal for rotating the receiving unit 4 by the calculated rotation angle θ to the motor control circuit 65. Thereby, the motor control circuit 65 drives the stepping motor 52 to rotate the receiving unit 4 by the calculated rotation angle θ as shown in FIG. 9B.

Subsequently, main measuring processing using the ultrasonic probe 2 is performed. In the main measuring processing, similarly to steps S1 to S3, the transmitting and receiving control unit 141 switches the switch circuit 61 to the transmission connection (step S7), and applies a drive voltage to the respective groups of ultrasonic transducers 36B of the transmitting unit 3 from the transmission circuit 62 (step S8). Further, the transmitting and receiving control unit 141 switches the switch circuit 61 to the reception connection (step S9), and controls the first reception circuit 63 and the second reception circuit 64 to detect reception signals (first reception signals) from the groups of ultrasonic transducers 46B of the receiving unit 4 and the second reception signals from the group of transmitting and receiving transducers 36B1 (step S10).

Note that, also, the processing from step S7 to step S10 may be performed at a plurality of times while the transmission direction of ultrasonic wave is changed by delaying the application time of the drive voltage input to the respective groups of ultrasonic transducers 36B with respect to each group of ultrasonic transducers 36B at step S8. In this case, ultrasonic waves may be transmitted to a predetermined scanning surface along the Y-direction and orthogonal to the transmitting unit 3 by the transmitting unit 3, and the measurement region may be set to a wider range (a nearly sector region about the transmitting surface 33A). In the embodiment, for convenience of explanation, a mode of outputting ultrasonic waves in the normal direction of the transmitting unit 3 (a mode without scanning with respect to the scanning surface) is exemplified.

Subsequently, the measuring unit 143 calculates the reflection position A based on the first reception signals input from the receiving unit 4 via the first reception circuit 63 and the second reception signals input from the transmitting unit 3 via the second reception circuit 64 (step S11). In other words, the reflection position A calculated based on the first reception signals is corrected based on the second reception signals.

As shown in FIG. 9B, when a direction U1 from the transmitting unit 3 toward the reflection position A and a direction U2 from the reflection position A toward the receiving unit 4 are different and the direction U1 and the direction U2 cross at the angle θ, the distance a from the transmitting unit 3 to the reflection position A and the distance b between the reflection position A and the receiving unit 4 are different.

When the receiving unit 4 is rotated, compared to the case where the receiving surface 43A is parallel to transmitting surface 33A, the reception distance extends by a distance d (=c×cosθ) according to a distance c from the rotation shaft 51 to the position in which the ultrasonic wave is received. Note that, in the embodiment, the respective ultrasonic transducers 46A belonging to the group of ultrasonic transducers 46B are connected by the lower electrode 434 and the signals from these ultrasonic transducers 46A are added and output. Therefore, in the embodiment, as the distance c, a distance from the rotation shaft 51 to a midpoint in the group of ultrasonic transducers 46B (average distance) is used.

The above described values a, b, c, and θ are used, and thereby, the reception distance b takes a value shown by the following expression (1).

b=(a/cosθ)+(c×sinθ) (1)

That is, in the respective groups of ultrasonic transducers 46B of the receiving unit 4, reception signals at the reception distances farther than the distance a from the ultrasonic probe 2 to the reflection position A by b−a (=(a/cosθ)+(c×sinθ)−a) are acquired. In other words, the reception signals output from the groups of ultrasonic transducers 46B of the receiving unit 4 are delayed by the time corresponding to the difference in reception distance (b−a) from the reception signals output from the group of transmitting and receiving transducers 36B1.

Therefore, the measuring unit 143 calculates a time by subtraction of a difference between a second time after the transmission of ultrasonic wave from the transmitting unit 3 and before output of the second reception signals and a first time after the transmission of ultrasonic wave from the transmitting unit 3 and before output of the first reception signals (corresponding to the difference in reception distance b−a) from the first time and calculates the real distance of the reflection position A based on the calculated time.

Then, the measuring unit 143 images the respective ultrasonic wave reflection positions within the living body based on the calculated real distances, and acquires inner tomographic images with respect to the living body (step S12).

### Advantages of Embodiment

The ultrasonic apparatus 1 of the embodiment has the ultrasonic probe 2 including the transmitting unit 3 including the transmitting surface 33A that transmits ultrasonic waves, the receiving unit 4 (first receiving unit) including the receiving surface 43A that receives ultrasonic waves reflected by a measuring object (reflection position A) within the living body, and the receiving attitude changing unit 5 that rotates the receiving unit 4. Further, the transmitting unit 3 of the ultrasonic probe 2 includes the group of transmitting and receiving transducers 36B1 (second receiving unit) that can receive ultrasonic waves.

In the configuration, the angle of the receiving unit 4 may be changed so that the reflection position A may face in the normal direction of the receiving surface 43A by the receiving attitude changing unit 5. Thereby, the reception direction of the reflected wave received by the receiving surface 43A is nearly aligned with the normal direction of the receiving surface, reduction of sound pressure of the received ultrasonic wave is suppressed, signal intensity of the first reception signals from the receiving unit 4 may be increased, and the highly accurate ultrasonic measurement less affected by noise or the like may be performed.

In the configuration in which the angle of the receiving surface 43A of the receiving unit 4 with respect to the transmitting surface 33A can be changed, it is impossible to calculate the real distance from the transmitting unit 3 to the reflection position A using only the first reception signals from the receiving unit 4. On the other hand, in the embodiment, the group of transmitting and receiving transducers 36B1 provided in the transmitting unit 3 receive the second reception signals according to the distance from the transmitting unit 3 to the reflection position A. Accordingly, the first reception signals are corrected based on the second reception signals, and thereby, the depth of the reflection position A may be obtained with higher accuracy. Therefore, the measurement accuracy in the ultrasonic apparatus 1 may be further improved.

In the embodiment, the transmitting unit 3 has the transmitting array 36 in which the plurality of ultrasonic transducers 36A are arranged. In the configuration, the plurality of ultrasonic transducers 36A are controlled, and thereby, highly accurate inner tomographic images with respect to a predetermined scanning surface within the living body may be acquired.

In the embodiment, the group of transmitting and receiving transducers 36B1 are provided at the center of the transmitting array 36. Thereby, the second reception signals based on the distance from the center position of the transmitting unit 3 to the reflection position A may be acquired.

In the embodiment, the group of transmitting and receiving transducers 36B1 are provided in the transmitting unit 3 and the group of transmitting and receiving transducers 36B1 form the second receiving unit.

Accordingly, the group of transmitting and receiving transducers 36B1 may perform not only reception of ultrasonic waves but also transmission of ultrasonic waves, and thereby, the output reduction of transmitted ultrasonic waves when the second receiving unit is provided in the transmitting unit 3 may be suppressed.

In the embodiment, the receiving unit 4 includes the receiving array 46 in which the plurality of ultrasonic transducers 46A are arranged in the array form. Accordingly, the plurality of ultrasonic transducers 46A (groups of ultrasonic transducers 46B) may measure the ultrasonic waves reflected in the reflection position A and, highly accurate measurement may be performed by calculation of the reflection position A based on these measurement results.

In the embodiment, the transmitting unit 3 includes the first acoustic lens 32 provided on the transmitting surface 33A and the receiving unit 4 includes the second acoustic lens 42 provided on the receiving surface 43A and having the same curvature as the first acoustic lens 32.

In the configuration, the first acoustic lens 32 is provided, and thereby, the ultrasonic waves transmitted from the respective positions on the transmitting surface 33A are output with phase differences according to the positions, and the ultrasonic waves may be transmitted to converge on a predetermined target position within the living body and the measurement accuracy is improved by the ultrasonic scanning measurement. Further, the second acoustic lens 42 has the same curvature as the first acoustic lens 32, and, when the reflected waves are received in the receiving unit 4 via the second acoustic lens 42, the phase differences generated when the ultrasonic waves pass through the first acoustic lens 32 at the transmission of the ultrasonic waves may be eliminated and highly accurate ultrasonic measurement may be performed.

In the embodiment, the attitude control unit 142 calculates the rotation angle θ such that the receiving unit 4 may face the reflection position A based on the reception signals from the group of transmitting and receiving transducers 36B1 (the second reception signals from the second reception circuit 64), and rotates the receiving unit 4 by the rotation angle θ. Accordingly, the angle of the receiving unit 4 may be appropriately controlled so that the sound pressure of the ultrasonic waves received by the receiving unit 4 may be higher.

### Second Embodiment

Next, the second embodiment will be explained.

In the above described first embodiment, the receiving unit 4 in the ultrasonic probe 2 is rotated by the receiving attitude changing unit 5, and thereby, the angle of the receiving surface 43A with respect to the transmitting surface 33A is changed and the ultrasonic waves in directions nearly aligned with the normal direction of the receiving surface 43A are received in the receiving unit 4. On the other hand, the second embodiment is different from the first embodiment in that, in addition to the receiving unit 4, the angle of the transmitting unit 3 can be changed.

Note that, for the following explanation, the configurations explained as above have the same signs and the explanation will be omitted.

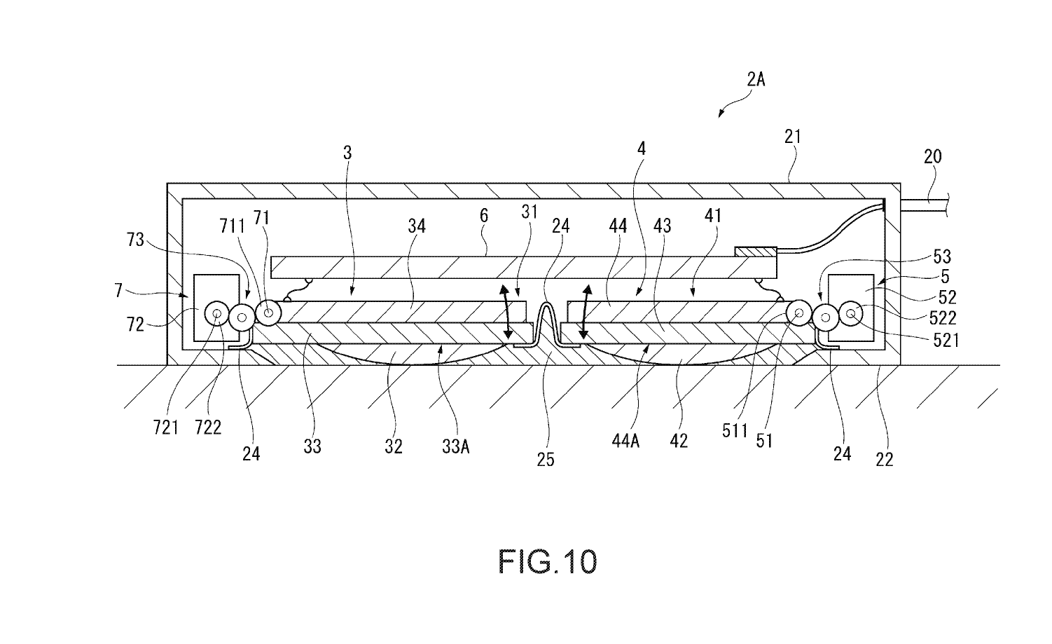

FIG. 10 is a schematic sectional view of an ultrasonic probe 2A of the second embodiment.

As shown in FIG. 10, in the ultrasonic probe 2A of the embodiment, a transmitting attitude changing unit 7 that rotates the transmitting unit 3 is provided.

The transmitting attitude changing unit 7 has nearly the same configuration as the receiving attitude changing unit 5, and includes a rotation shaft 71, a stepping motor 72, and a drive transmission part 73. The rotation shaft 71 is fixed to the end of the transmission reinforcing plate 34 of the transmitting unit 3 on the opposite side to the receiving unit in the X-direction and rotates with the transmission reinforcing plate 34 (transmitting unit 3). A third gear 711 is provided on a part (e.g. an end) of the rotation shaft 71.

The stepping motor 72 is electrically connected to the circuit board 6, for example, and driven based on a signal from the control unit 10 to rotate a motor shaft 721 about the shaft center. On the motor shaft 721, a fourth gear 722 is provided. The stepping motor 72 is connected to the motor control circuit 65 of the circuit board 6 like the stepping motor 52 of the receiving attitude changing unit 5. Note that the motor control circuit 65 is adapted to individually control the stepping motor 52 of the receiving attitude changing unit 5 and the stepping motor 72 of the transmitting attitude changing unit 7.

The drive transmission part 73 includes e.g. one or more gears that connect the third gear 711 and the fourth gear 722. When the stepping motor 72 is driven and the motor shaft 721 is rotated, the drive power is transmitted from the fourth gear 722 to the third gear 711 via the drive transmission part 73, and the rotation shaft 71 rotates. Thereby, the transmitting unit 3 rotates with the rotation shaft 71.

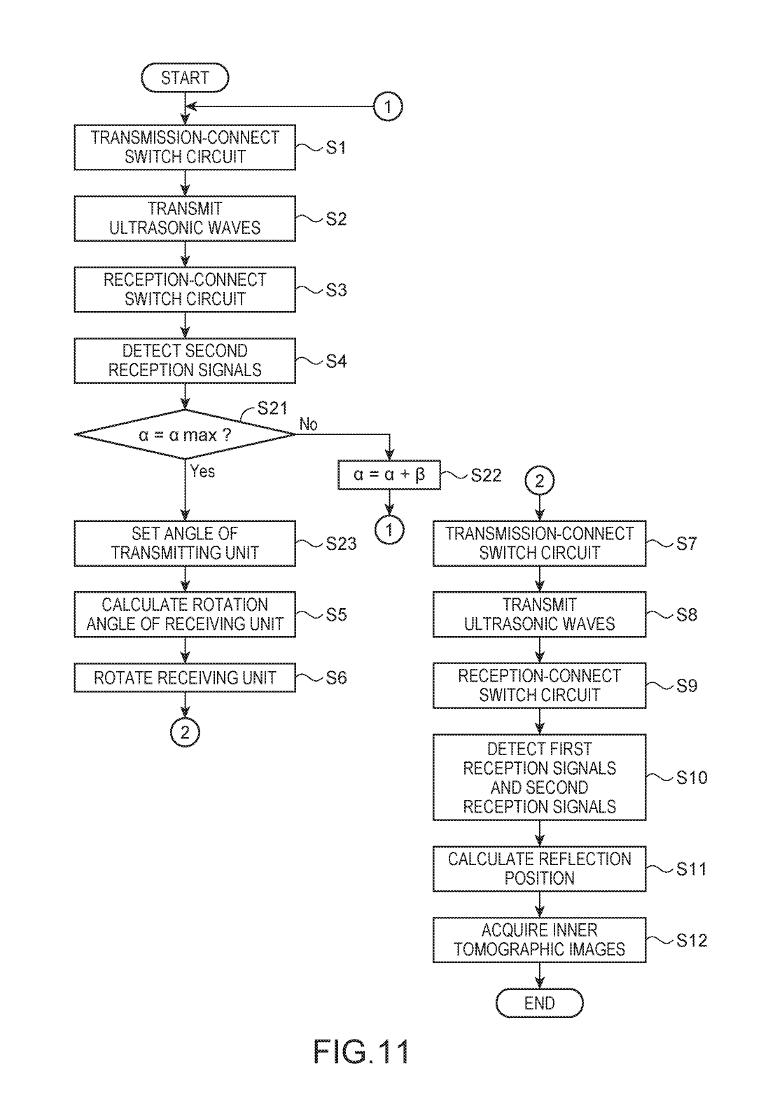

FIG. 11 is a flowchart showing an ultrasonic measuring method of the second embodiment.

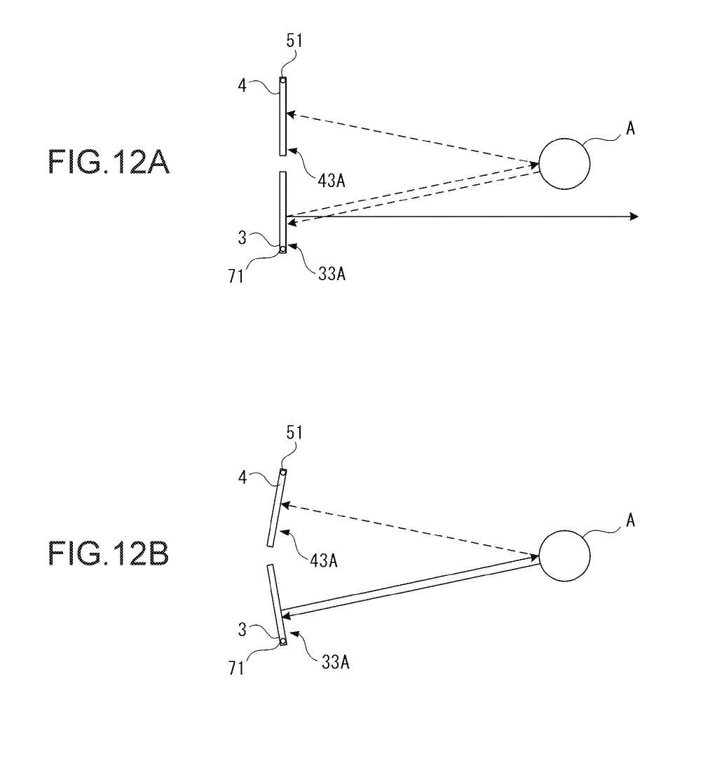

FIGS. 12A and 12B are diagrams for explanation of attitude control of the transmitting unit and the receiving unit in the second embodiment.

In the embodiment, ultrasonic measurement is performed by nearly the same processing as that of the first embodiment.

Specifically, in the embodiment, first, a rotation angle α of the transmitting unit 3 is returned to an initial value (α=0) and processing at the same step S1 to step S4 as those in the first embodiment is performed.

Then, the attitude control unit 142 determines whether or not the rotation angle α of the transmitting unit 3 is a predetermined limit value (αmax) (step S21).

If a determination of No is made at step S21, a predetermined value β is added to the rotation angle α (step S22). That is, the attitude control unit 142 rotates the transmitting unit 3 by the predetermined value β. Then, the processing at the step S1 to step S4 is repeatedly performed.

The above described processing is repeated, and thereby, the transmitting unit 3 is rotated from the predetermined initial value (0°) to the limit value (αmax) and the second reception signals from the second reception circuit 64 at the respective rotation angles are detected.

On the other hand, if a determination of Yes is made at step S21, the attitude control unit 142 detects the maximum value of the second reception signals detected at step S4, and changes the angle of the transmitting unit 3 to the rotation angle α when the maximum value is detected (step S23).

That is, the ultrasonic wave transmitted from the transmitting unit 3 is transmitted with a certain level of breadth, however, when a target measuring object site (reflection position A) does not exist in the ultrasonic wave transmission direction of the transmitting unit 3, as shown in FIG. 12A, the reflected wave is smaller and the second reception signal is smaller.

On the other hand, in the position in which the second reception signal is the maximum after the rotation of the transmitting unit 3, as shown in FIG. 12B, the target measuring object site exists in the ultrasonic wave transmission direction of the transmitting unit 3. By the processing at step S23, the rotation angle α of the transmitting unit 3 is set in the position as shown in FIGS. 12B.

Subsequently, as is the case of the first embodiment, the processing from step S5 to step S12 is performed.

### Advantages of Embodiment

In the ultrasonic probe 2A in the ultrasonic apparatus 1 of the embodiment, both the transmitting unit 3 and the receiving unit 4 are adapted so that the rotation angles can be changed by the transmitting attitude changing unit 7 and the receiving attitude changing unit 5, respectively.

Accordingly, also, in the transmitting unit 3, the rotation angle may be changed so that the transmission direction of ultrasonic wave may face the target measuring object site within the living body. Thereby, ultrasonic waves with strong sound pressure may be transmitted to the measuring object site, and the sound pressure of the reflected waves received by the receiving unit 4 becomes stronger and the measurement accuracy may be further improved.

In the configuration in which only one of the transmitting unit 3 and the receiving unit 4 is rotated, the rotation angle becomes larger. That is, as known from the comparison between FIGS. 9B and 12B, the rotation angle of the receiving unit 4 shown in FIG. 9B is larger than the rotation angle of the receiving unit 4 shown in FIG. 12B. On the other hand, in the embodiment, the transmitting unit 3 and the receiving unit 4 are rotated, and the respective rotation angles may be suppressed to be smaller. That is, when the rotation angles of the transmitting unit 3 and the receiving unit 4 are larger, it is necessary to increase the size of the thickness dimension of the casing 21 and the probe size is increased. However, in the embodiment, the ultrasonic probe 2A may be downsized.

Further, in the embodiment, the transmitting unit 3 is rotatable, and thereby, when the ultrasonic probe 2A is fixed to the living body, even in the case where the target measuring object site does not exist in the normal direction of the transmitting surface 33A, measurement may be continued by changing the rotation angle of the transmitting unit 3 without the need of refixing the ultrasonic probe 2A.

Furthermore, in the embodiment, the transmitting unit 3 is rotated, and thereby, the scanning surface (the surface containing the normal direction of the transmitting surface 33A and the Y-direction as the arrangement direction of the plurality of groups of ultrasonic transducers 36B) may be rotated about the rotation shaft 71.

In this case, the respective inner tomographic images with respect to the rotation angles of the transmitting unit 3 are acquired and these inner tomographic images are synthesized, and thereby, a three-dimensional image inside the living body can be synthesized. Specifically, the transmitting and receiving control unit 141 associates the respective reception signals (first reception signals and second reception signals) obtained by the ultrasonic measurement using the ultrasonic probe 2A with the rotation angles of the transmitting unit 3 and stores them in the memory part 13. Then, the measuring unit 143 forms the respective inner tomographic images with respect to the respective rotation angles and connects these inner tomographic images based on the associated angles on the three-dimensional coordinates. The above described three-dimensional image is used, and thereby, the tissue within the living body may be analyzed in more detail.

### Third Embodiment

Next, the third embodiment will be explained.

In the above described first embodiment, the example in which the group of transmitting and receiving transducers 36B1 along the X-direction at the center in the transmitting array 36 of the transmitting unit 3 function as the second receiving unit is shown. On the other hand, the embodiment is different from the first embodiment in that a plurality of groups of transmitting and receiving transducers are provided.

The transmitting unit 3 of the ultrasonic probe 2 in the third embodiment has the same configuration as that of the first embodiment as shown in FIG. 4.

Here, in the embodiment, of the plurality of groups of ultrasonic transducers 36B arranged along the Y-direction, groups of transmitting and receiving transducers 36B2 (see FIG. 4) as the second receiving unit are provided in the end portions on the ±Y sides, for example. In other words, in the embodiment, with the center position of the transmitting array 36 in the Y-direction as a reference position, the groups of ultrasonic transducers 36B provided in positions line symmetric with respect to the reference position function as the groups of transmitting and receiving transducers 36B2 (second receiving unit).

Specifically, these groups of transmitting and receiving transducers 36B2 are connected to the switch circuit 61 in the circuit board 6, and transmission connection to be connected to the transmission circuit 62 and reception connection to be connected to the second reception circuit 64 can be switched.

### Advantages of Embodiment

In the embodiment, the groups of transmitting and receiving transducers 36B2 forming the second receiving unit are provided in positions symmetric with respect to the center of the transmitting array 36.

In the embodiment, the first reception signals are corrected based on the second reception signals, and, for improvement of the correction accuracy, it is preferable to acquire the second reception signals with higher accuracy. Therefore, according to the above described configuration, the second reception signals based on the distance a from the transmitting unit 3 to the reflection position A may be acquired with higher accuracy based on the second reception signals from the plurality of groups of transmitting and receiving transducers 36B2. Thereby, the accuracy of the reflection position A calculated by the measuring unit 143 (depth true value) may be higher and highly accurate measurement may be performed.

Further, the distance a from the transmitting unit 3 to the reflection position A may be calculated with higher accuracy, and thereby, the rotation angle θ of the receiving unit 4 may be calculated with higher accuracy. That is, the rotation angle of the receiving unit 4 may be controlled with higher accuracy so that the stronger signal intensity may be obtained when the reflected waves are received by the receiving unit 4.

### Fourth Embodiment

Next, the fourth embodiment will be explained.

In the above described first embodiment, the example in which the group of transmitting and receiving transducers 36B1 are provided in the transmitting unit 3, and thereby, the second receiving unit that can perform both transmission and reception of ultrasonic waves is provided is shown. On the other hand, the embodiment is different from the first embodiment in that the second receiving unit does not perform transmission of ultrasonic waves, but performs only reception of ultrasonic waves.

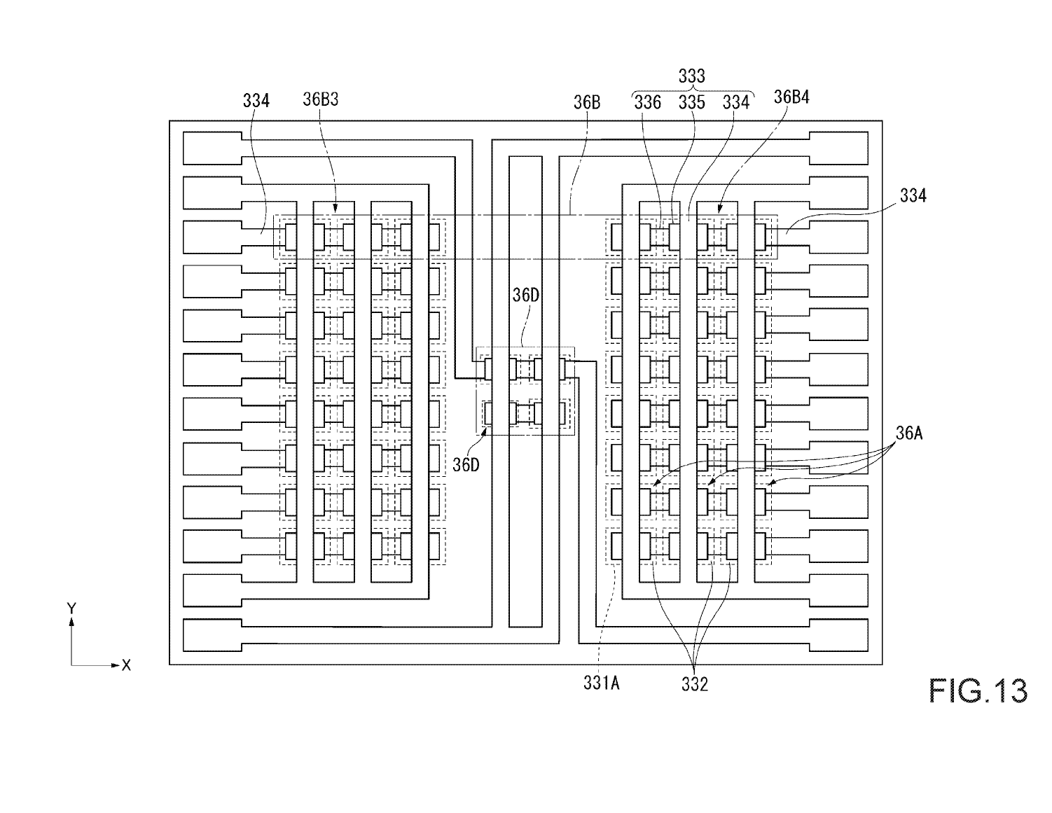

FIG. 13 is a plan view showing a schematic configuration of a transmitting device board forming a transmitting unit of the fourth embodiment.

As shown in FIG. 13, the transmitting device board 33 of the embodiment includes ultrasonic transducers 36A for ultrasonic transmission and ultrasonic transducers 36C for reception forming the second receiving unit according to the invention in the transmitting array 36.

Here, as is the case of the first embodiment, a 1-ch group of ultrasonic transducers 36B are formed by the plural ultrasonic transducers 36A arranged in the X-direction. In the example of FIG. 13, one group of ultrasonic transducers 36B are divided into a first group of ultrasonic transducers 36B3 provided on the −X side and a second group of ultrasonic transducers 36B4. The lower electrodes 334 of these first group of ultrasonic transducers 36B3 and second group of ultrasonic transducers 36B4 are separated on the transmitting device board 33, however, connected on the circuit board 6 and an SIG signal is applied from the transmission circuit 62 thereto. The same applies to the upper electrodes 336 and the ultrasonic transducers are divided into ultrasonic transducers 36A provided on the −X side and ultrasonic transducers 36A provided on the +X side, however, the upper electrodes 336 are connected on the circuit board 6 and a COM signal is applied from the transmission circuit 62 thereto.

On the other hand, for example, a plurality (four in the embodiment) of the receiving transducers 36C are provided at the center of the transmitting array 36.

These receiving transducers 36C have the same configurations as those of the ultrasonic transducers 36A and each has the vibrating diaphragm 332 closing the opening portion 331A and the piezoelectric element 333. Note that, as shown in FIG. 13, the opening area of the opening portion 331A corresponding to the receiving transducer 36C may be formed to be smaller than the opening area of the opening portion 331A corresponding to the ultrasonic transducer 36A. In this case, ultrasonic waves at a frequency different from that of the ultrasonic waves transmitted from the transmitting unit 3 can be received by the receiving transducers 36C. For example, this case is advantageous when ultrasonic waves are transmitted from the transmitting unit 3 and harmonics (second harmonics or the like) reflected from the measuring object are received.

Regarding these receiving transducers 36C, one group of receiving transducers 36D are formed by a plurality (four) of receiving transducers 36C having the lower electrodes 334 connected to each other, for example. Note that, in the embodiment, an example in which only one group of receiving transducers 36D are provided is shown, however, a plurality of group of receiving transducers 36D may be provided.

### Advantages of Embodiment

In the embodiment, the transmitting unit 3 includes the receiving transducers 36C as the second receiving unit. In the configuration, the area of the vibrating diaphragm 332 (the opening area of the opening portion 331A) forming the receiving transducer 36C may be set to an area according to the frequency of the reflected wave to be received. Therefore, for example, when second harmonics or the like are received, ultrasonic waves may be received with higher accuracy.

### Other Modified Examples

The invention is not limited to the above described respective embodiments, but includes configurations obtained by appropriate combinations of modifications, improvements, the respective embodiments, etc. in a range in which the purpose of the invention may be achieved.

In the above described first embodiment, the configuration including the receiving attitude changing unit 5 that changes the rotation angle of the receiving unit 4 is employed, however, a configuration further including a distance changing unit that changes the distance from the transmitting unit 3 by slidingly moving the receiving unit 4 or the like may be employed. In this case, even when it is impossible to set the reception direction toward the reflection position A only by the angle change of the receiving unit 4, and the reception signal of reflected waves is smaller, the reflected waves may be suitably received and the reception signals may be made larger by further changing the distance between the receiving unit 4 and the transmitting unit 3.

Further, the mode of changing the angle of the receiving unit 4 by the receiving attitude changing unit 5 is exemplified in the first embodiment and the mode of changing the angles of the receiving unit 4 and the transmitting unit 3 by the receiving attitude changing unit 5 and the transmitting attitude changing unit 7 is exemplified in the second embodiment, however, the invention is not limited to those. For example, a configuration in which the attitude of the receiving unit 4 is fixed and the attitude (rotation angle) of the transmitting unit 3 is changeable may be employed.

In the above described embodiments, the example in which the ultrasonic transducers 46A forming the receiving unit 4 have the same configurations as the ultrasonic transducers 36A forming the transmitting unit 3 is shown, however, the invention is not limited to that. For example, each of the ultrasonic transducers 46A forming the receiving unit 4 may have a configuration in which a pair of electrodes are provided to face each other on one surface side orthogonal to the thickness direction of the piezoelectric film 435. Or, electrodes may be provided to sandwich the piezoelectric film on a side surface along the thickness direction of the piezoelectric film. In the ultrasonic transducer having the configuration, the potential difference between the first electrode and the second electrode when the vibrating diaphragm vibrates may be made larger, and the reception signal at reception of ultrasonic wave may be made larger.

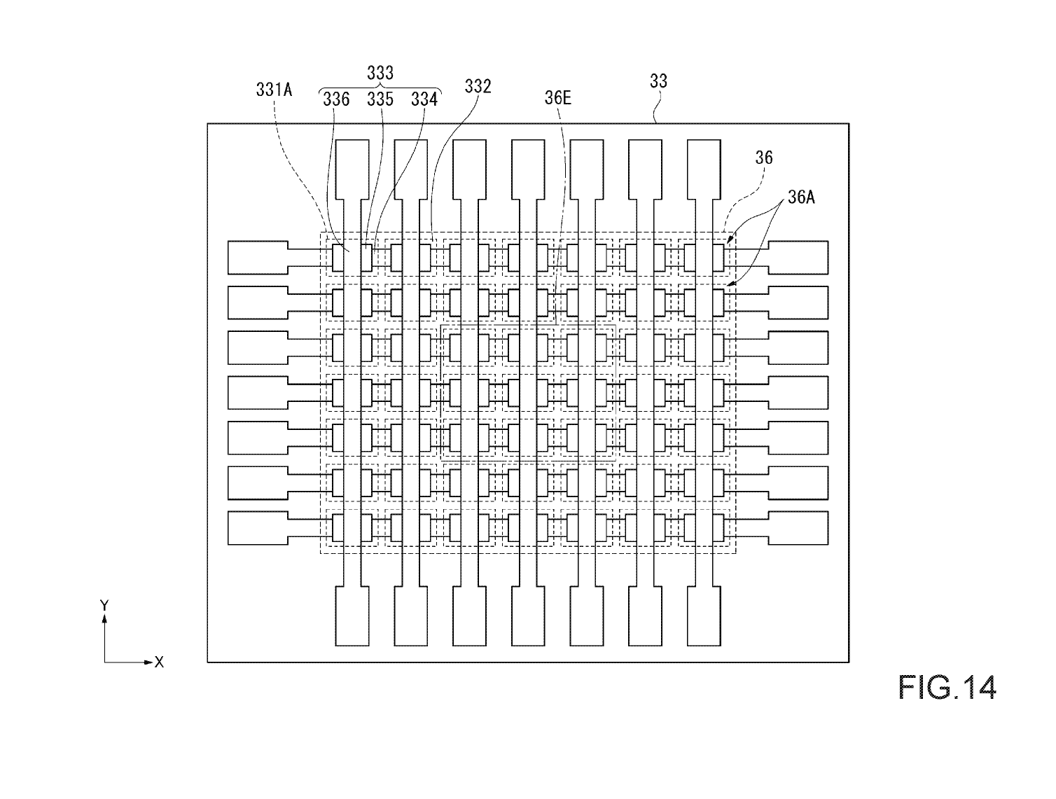

In the above described embodiments, in the transmitting unit 3, the transmitting array 36 having the one-dimensional array structure in which the lower electrode 334 is common among the plurality of ultrasonic transducers 36A arranged along the X-direction and the upper electrode is common in all ultrasonic transducers 36A within the transmitting array 36 is exemplified, however, the invention is not limited to that. FIG. 14 shows a configuration example of a transmitting device board of another embodiment.

As shown in FIG. 14, a configuration in which the lower electrode 334 is common among the respective ultrasonic transducers 36A arranged along the X-direction and the upper electrode 336 is common among the respective ultrasonic transducers 36A arranged along the Y-direction, and signals can be individually input to these lower electrode 334 and upper electrode 336 may be employed. In this case, for example, a region containing nine ultrasonic transducers 36A provided in the center position of the transmitting array 36 may function as a second receiving unit 36E. Specifically, the ultrasonic transducers 36A contained in the second receiving unit 36E may be connected to the switch circuit 61 as transmitting and receiving transducers as is the case of the first embodiment.

Note that the same applies to the receiving unit 4 and a receiving array 46 having a two-dimensional array structure may be formed.

In the configuration, the respective ultrasonic transducers 36A may be individually driven and ultrasonic waves toward an arbitrary convergence position may be transmitted by delay control of the respective ultrasonic transducers 36A or the like. Therefore, the first acoustic lens 32 and the second acoustic lens 42 may be unnecessary.

In the above described first embodiment, ultrasonic waves are transmitted from the transmitting unit 3, the distance between the transmitting unit 3 and the reflection position A is calculated based on the second reception signals detected by the group of transmitting and receiving transducers 36B1 (second receiving unit), the rotation angle θ of the receiving unit 4 is calculated based on the distance, and the attitude of the receiving unit 4 is changed.

On the other hand, ultrasonic waves may be transmitted from the transmitting unit 3, the rotation angle θ of the receiving unit 4 may be changed by a predetermined angle at a time, the rotation angle θ at which the first reception signal output from the receiving unit 4 may be detected, and thereby, the rotation angle θ of the receiving unit 4 may be set.

In addition, the specific structure when the invention is embodied may be formed by an appropriate combination of the above described embodiments and modified examples in a range in which the purpose of the invention may be achieved or may be appropriately changed to another structure.

The entire disclosure of Japanese Patent Application No. 2016-008069, filed on Jan. 19, 2016 is expressly incorporated by reference herein.

What is claimed is:

1. An ultrasonic probe comprising:
a transmitting unit that transmits ultrasonic waves;
a first receiving unit that receives the ultrasonic waves; and
a changing mechanism that changes arrangement of at least one of the transmitting unit and the first receiving unit,
wherein apart of the transmitting unit includes a second receiving unit that can receive the ultrasonic waves.

2. The ultrasonic probe according to claim 1, wherein the transmitting unit includes a transmitting array in which a plurality of ultrasonic transmitting transducers that transmit the ultrasonic waves are arranged in an array form.

3. The ultrasonic probe according to claim 2, wherein the second receiving unit is provided at a center of the transmitting array.

4. The ultrasonic probe according to claim 2, wherein a plurality of the second receiving units are provided, and
the plurality of second receiving units are arranged in positions symmetric with respect to a predetermined reference position in the transmitting array.

5. The ultrasonic probe according to claim 1, wherein the second receiving unit is a transmitting and receiving transducer that can transmit and receive the ultrasonic waves.

6. The ultrasonic probe according to claim 1, wherein the second receiving unit is a receiving transducer that performs reception of the ultrasonic waves.

7. The ultrasonic probe according to claim 1, wherein the first receiving unit includes a receiving array in which a plurality of ultrasonic receiving transducers that receive the ultrasonic waves are arranged in an array form.

8. The ultrasonic probe according to claim 1, wherein the transmitting unit includes a first acoustic lens,
the first receiving unit includes a second acoustic lens, and
a curvature of the first acoustic lens and a curvature of the second acoustic lens are equal.

9. An ultrasonic apparatus comprising:
an ultrasonic probe including a transmitting unit that transmits ultrasonic waves, a first receiving unit that receives the ultrasonic waves, and a changing mechanism that changes arrangement of at least one of the transmitting unit and the first receiving unit, a part of the transmitting unit including a second receiving unit that can receive the ultrasonic waves; and
a control unit that controls the ultrasonic probe.

10. The ultrasonic apparatus according to claim 9, wherein the control unit controls the changing mechanism so that a reception signal from the first receiving unit may be equal to or larger than a predetermined value based on a reception signal from the second receiving unit.
